(19) United States
(12) Patent Application Publication
(10) Pub. No.: US 2023/0366378 A1
(43) Pub. Date: Nov. 16, 2023

(54) WIND TURBINE FOR GENERATING ELECTRICAL ENERGY FROM EXHAUST ENERGY AND A SYSTEM THEREOF

(71) Applicant: Revayu Systems Private Limited, New Delhi (IN)

(72) Inventors: Prateek Kumar Gupta, Greater Noida (IN); Siddharth Arora, New Delhi (IN)

(21) Appl. No.: 18/196,654

(22) Filed: May 12, 2023

Related U.S. Application Data
(60) Provisional application No. 63/341,622, filed on May 13, 2022.

(51) Int. Cl. F03D 9/00; F03D 7/02; H02K 7/18

(52) U.S. Cl. CPC F03D 9/00; F03D 7/0276; H02K 7/183; F05B 2270/327

(57) ABSTRACT

The present disclosure relates to a wind turbine for generating electrical energy from exhaust energy and a system thereof. The wind turbine comprises a plurality of 3D Sphero dynamic blades, a rotor, and a generator. Each of the plurality of blades is configured to receive exhaust air from air exhausting devices, such as, industrial exhaust fans or ventilators, and is configured to rotate. The rotation of the plurality of blades is self-controlled and generates non-uniform AC power. The system comprises a rectifier and an inverter to convert the non-uniform AC power into a uniform AC power, which is fed to a power grid or is used in the premises.

### CROSS REFERENCE TO RELATED APPLICATIONS

This patent application claims priority benefit of U.S. Provisional Patent Application No. 63/341,622, entitled “A WIND TURBINE FOR GENERATING ELECTRICAL ENERGY FROM EXHAUST ENERGY AND A SYSTEM THEREOF”, filed on May 13, 2022. The entire content of the patent application is hereby incorporated by reference herein in its entirety.

### FIELD OF THE DISCLOSURE

The present disclosure generally relates to a wind turbine. More particularly, the present disclosure relates to a wind turbine for generating electric energy from exhaust energy and a system thereof.

### BACKGROUND

Search for alternate sources of energy in recent years is highly increased. Such alternate sources of energy are solar panels, wind turbines, hydro power plants, tidal power plants, biofuel plants, geothermal energy, and the like. Such available renewable sources of energy have certain limitations. For instance, energy generation by conventional wind turbines is highly dependent on the weather, time of the day, season of the year, and the like. Further, such wind turbines require specific location, such as open space having certain radius on the field or in the ocean. Furthermore, such wind turbines cause damage to surrounding wildlife. Moreover, blades of the conventional wind turbine are easily damaged due to the environmental effects, and hence, frequent service and maintenance is required in the conventional wind turbines.

To use the renewable sources of energy more efficiently, such alternate sources of energy can be used along with available resources for energy generation. For instance, use of exhaust fans and ventilators for removing hot air is common in most of the industries. Operation of the industrial exhaust fans or ventilators consume a lot of power. The exhaust fans or ventilators use traditional equipment such as diesel generator to operate. Such equipment are very expensive. Also, they use traditional fuel, such as diesel, which increases carbon footprint which results in increased air pollution and decreased air quality

The exhaust fans and ventilators throw exhaust air. Such exhaust air, also referred as artificially generated wind, is generated continuously, and has a certain rate of flow due to rotational movement of the blades of the exhaust fans. Generally, such exhaust air is released in a duct or in the environment. As the industrial exhaust fans and ventilators operate continuously, they generate a tremendous amount of exhaust air or artificially generated wind. Such exhaust air contains some amount of kinetic energy. As the exhaust air is released in surrounding environment or in a duct, the kinetic energy contained in the artificially generated wind is not used, and hence, such huge amount of energy is wasted.

Hence, there is a need of a solution which utilizes the exhaust energy and renewable energy source to generate electrical energy.

### SUMMARY

The present disclosure sets forth a wind turbine for generating electrical energy from exhaust energy. The exhaust energy may be in form of exhaust air received from an air exhausting device. The wind turbine comprises a plurality of blades configured to receive a flow of exhaust air and further configured to rotate at a speed. The turbine further includes a rotor and a generator. The rotor is configured to be rotated based on the rotation of the plurality of blades, and the generator is configured to generate an electrical signal based on the rotation of the rotor. Each of the plurality of blades is of a 3D Sphero dynamic shape and is attached to the rotor at a first angle so as to reduce back pressure of the exhaust air. Further, the speed of the plurality of blades corresponds to the flow of exhaust air.

In some embodiments, the wind turbine further includes a governing mechanism for controlling the speed of rotation of the plurality of blades. The governing mechanism comprises a controller and a furling apparatus. The controller is configured to monitor the speed of rotation of the plurality of blades and is further configured to generate a furling signal in case the speed is more than a second reference speed. On receiving the furling signal, the furling apparatus changes an angle of the plurality of blades with respect to a rotating axis of the rotor.

The present disclosure further sets forth a system for generating electrical energy from exhaust energy. The system comprises a wind turbine, a rectifier, and an inverter. The wind turbine comprises a rotor, a plurality of blades, and a generator. Each of the plurality of blades are attached to the rotor at a first angle. The plurality of blades is configured to receive a flow of exhaust air from an air exhausting device and further configured to rotate at a first speed corresponding to the flow of the exhaust air, thereby rotating the rotor. The generator is configured to generate non-uniform AC power based on the rotation of the rotor. The rectifier is configured to receive the non-uniform AC power and further configured to generate a uniform DC power, while the inverter is configured to receive the uniform DC power and further configured to generate a uniform AC power.

In some embodiments, the plurality of blades are configured to be rotated up to a first reference speed, being 300 RPM.

### BRIEF DESCRIPTION OF THE DRAWINGS

A more complete understanding of the present disclosure may be derived by referring to the detailed description and claims when considered in connection with the Figures, wherein like reference numerals refer to similar elements throughout the Figures, and

FIG. 1 illustrates an exemplary wind turbine in accordance with the present disclosure.

FIG. 2 illustrates an exemplary blade of a wind turbine in accordance with the present disclosure.

FIG. 3 illustrates an exemplary block diagram of a system for generating electrical energy from exhaust energy according to one embodiment of the present disclosure; and

FIG. 4 illustrates an exemplary perspective view of a system with an exemplary exhaust fan according to an embodiment of the present disclosure.

### DETAILED DESCRIPTION

The following description is of exemplary embodiments of the invention only, and is not intended to limit the scope, applicability, or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternatively configured devices having different shapes, components, attachment mechanisms and the like and still fall within the scope of the present invention. Thus, the detailed description herein is presented for purposes of illustration only and not of limitation.

Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Embodiments of the present disclosure describe a wind turbine that is configured to generate electrical energy from exhaust air received from an air exhausting device. Hence, electrical energy can be generated from the exhaust air, which otherwise is merely discharged in an environment. The, hence, generated electrical energy may be used in a power grid or in the same premises itself, thereby encouraging less use of non-renewable sources of energy, and hence, reducing carbon footprints.

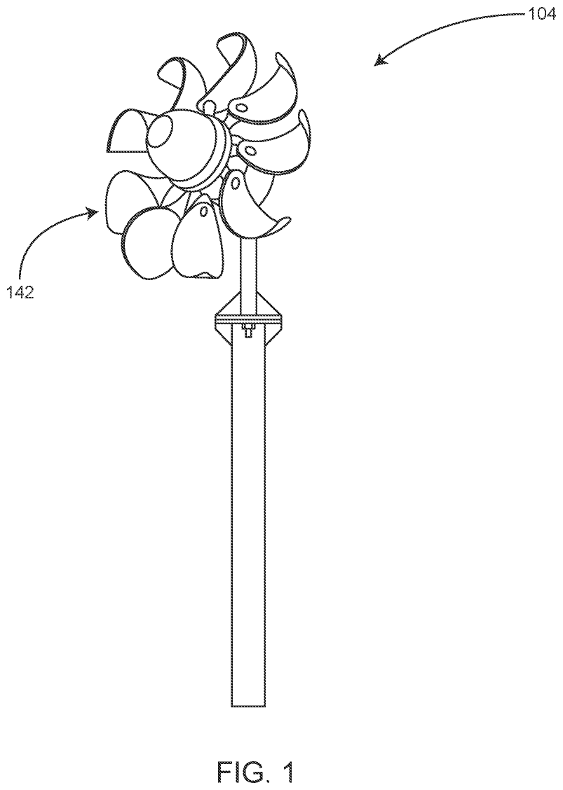

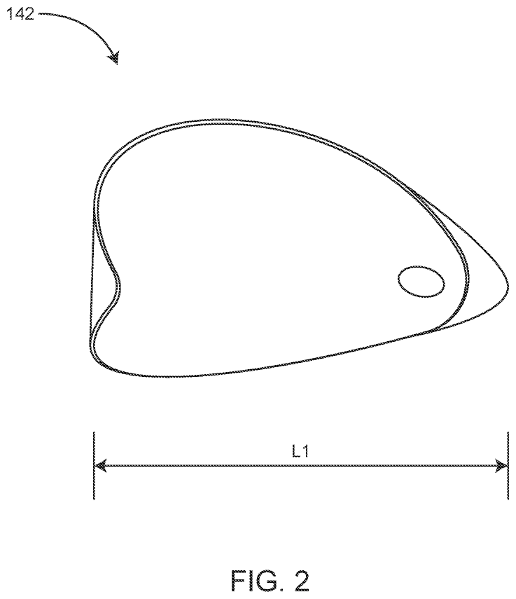

Reference is initially made to FIGS. 1 and 2, which illustrate a wind turbine 104 in accordance with the present disclosure. The wind turbine is configured to generate electrical energy from exhaust air generated by air exhausting devices. The term ‘exhaust energy’ as used in the present disclosure is intended to refer to energy generated by air exhausting devices. Some non-limiting examples of such air exhausting devices are industrial exhaust fans, air ventilators, air extractors, and the like. The exhaust energy in such cases may be referred to kinetic energy of exhaust air discharged by said air exhausting devices. The air exhausting devices consume a lot of power and continuously throw out artificially generated wind, which is a wasted resource. The system of the present disclosure utilizes the thrown exhaust air to generate electrical energy.

The wind turbine 104 comprises a plurality of 3D Sphero dynamic blades 142. The 3D Sphero dynamic shape is configured to have a first surface area. The first surface area is significantly larger than a surface area of a convention blade. Accordingly, a large volume of exhaust air is received on each of the plurality of blades. Hence, more exhaust air is received on each of the plurality of blade. As a result, a coefficient of energy for the wind turbine is high, which facilitates in designing a blade of a wind turbine that is smaller than a conventional wind turbine. Hence, the wind turbine of the present disclosure facilitates flexibility of using the plurality of blades having smaller length. In an embodiment, a length L1 of the plurality of blades of the wind turbine are ⅓rd of the length of the conventional wind turbine. In an exemplary embodiment, the length L1 of each of the plurality of blades is 70 cm. Such design flexibility enables placement of the wind turbine having smaller surrounding space, especially, in enclosed premises.

Due to the 3D Sphero dynamic shape of the plurality of blades 142, the most amount of uniform exhaust air is received by the plurality of blades 142. In an embodiment, 90 percent of the exhaust air is received by the plurality of blades 142. Such a high amount of exhaust air results in more energy conversion efficiency by the wind turbine 104.

In some embodiments, the 3D Sphero dynamic shaped blades 142 are attached to the rotor at a first angle with a rotating axis of the rotor. The first angle of the plurality of blades 142 is selected such that maximum volume of exhaust air is disbursed and no back-pressure is generated while rotation of the plurality of blades 142. Such structure contributes to high efficiency of the wind turbine without obstructing the exhaust air and helps in generating more power. In an embodiment, the first angle is selected such as the exhaust air hits each of the plurality of blades perpendicularly or substantially perpendicular, thereby ensuring that less or no resistance is created while the exhaust air is flowing towards the plurality of blades 142.

Additionally, each of the plurality of blades 142 are edgeless. Hence, an air resistance faced by the edgeless blades 142 is less, which results in less wear and tear to the plurality of blades 142. As a result, the plurality of blades 142 require less maintenance and have long life span. In an embodiment, the plurality of blades 142 may have a life span as long as 20 years. As a result, the wind turbine 104 in accordance with the present disclosure is cost-effective. Additionally, because of the edgeless feature of the plurality of blades, the blades are completely harmless to wildlife.

The wind turbine is configured to have a number of the plurality of blades. In an embodiment, the number of blades 142 used in the wind turbine 104 is 9 to achieve an efficiency of 90%. However, use of higher or lesser number of blades for achieving desired efficiency does not deviate scope of the present disclosure. Accordingly, the wind turbine 104 may be configured to have more or lesser number of blades 142 to achieve a desired efficiency.

In some embodiments, the plurality of blades 142 are configured to be rotated up to a first reference speed. In an exemplary embodiment, the plurality of blades are configured to be rotated up to a speed of 300 RPM. It is to be noted that the speed of 300 RPM corresponds to a rate of flow of the exhaust air. Accordingly, the speed of rotation of the plurality of blades 142 corresponds to the flow of the exhaust air. In an embodiment, the air exhausting device is configured to throw the exhaust air at a rate of 10 m/s. Accordingly, the speed of the plurality of blades of 300 RPM corresponds to the flow of the exhaust air having 10 m/s. Such speed of rotation of the plurality of blades 142 (300 RPM or less) results in less vibration, and hence, the rotation of the plurality of blades 142 generates less noise. In an embodiment, the speed of less than 300 RPM is achieved when the rate of the uniform airflow is less than 10 m/s, such as, 6-8 m/s. In some embodiments, to limit the speed of the plurality of blades 142, a number of poles of the rotor are increased.

In some embodiments, the wind turbine comprises a governing mechanism (not shown) to control the speed of rotation of the plurality of blades 142. In an embodiment, the governing mechanism is activated when the speed of rotation of the plurality of blades 142 is more than the first reference speed, i.e., more than 300 RPM. In case the speed exceeds the first reference speed (300 RPM), the governing mechanism is activated to facilitate furling the plurality of shaft. The governing mechanism is activated manually or automatically. In an embodiment, the governing apparatus comprises a controller and a furling mechanism. On detection of the speed of rotation of the plurality of blades is more than 300 RPM (i.e., the exhaust air flows at a rate more than 10 m/s), the controller generates a furling signal to activate the furling apparatus. The furling apparatus is configured to change the angle of the plurality of blades with the rotating axis from the first angle to a second angle. In such case, the plurality of blades 142 are configured to receive less amount of exhaust air, thereby reducing rotational speed of the plurality of blades. Accordingly, the speed of the plurality of blades 142 is kept at or below 300 RPM. In an embodiment, the governing mechanism is activated when the rate of the exhaust airflow is more than 10 m/s.

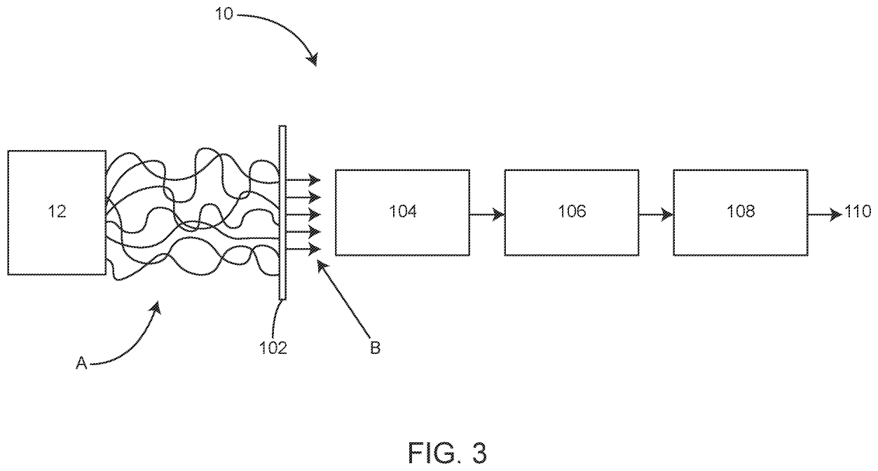

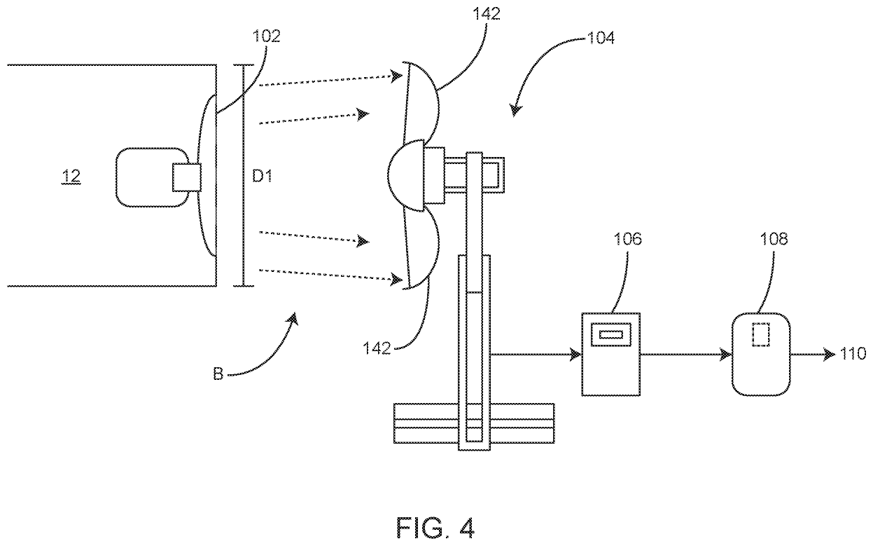

Reference is now made to FIGS. 3 and 4, which illustrate an exemplary system 10 for generating electrical energy from an exhaust energy received from the air exhausting device 12 according to the present disclosure. Some non-limiting examples of such air exhausting devices 12 are industrial exhaust fans, air ventilators, air extractors, and the like. The exhaust air from the air exhausting device 12 may be in a non-uniform pattern. The direction of flow of the exhaust air varies at edges of the exhaust fans and at center. Such non-uniform exhaust air is illustrated as ‘A’ in FIG. 3. The system 10 comprises an airflow distributor 102 that is configured to receive such non-uniform exhaust air A from the air exhausting device, 12, such as, an exhaust fan, and is further configured to convert the non-uniform air into a uniform exhaust air. The non-uniform airflow has uneven pressure. The non-uniform airflow with the uneven pressure, if received on the plurality of blades 142, may lead to internal and/or external damage to the plurality of blades 142 and/or the turbine 104. The airflow distributor 102 generates the uniform airflow so as to distribute the pressure of the exhaust air evenly. Accordingly, the airflow received on the plurality of blades has distributed/uniform pressure, thereby preventing any possible damage from the uneven pressure of the non-uniform airflow. The airflow distributor 102 may be an air flow straightener or an airflow augmenter for generating uniform flow of air. It is to be noted that the airflow distributor 102 does not change the rate of flow of the exhaust air.

Generally, the air exhausting devices 12 are configured to discharge the non-uniform exhaust air for a certain duration of time during a day. The exhaust fans may be configured to discharge non-uniform exhaust air continuously. A rate of flow of the non-uniform exhaust air may be constant. In some cases, a rate of flow of the non-uniform exhaust air may be variable. In an embodiment, the rate of flow of the exhaust air may be less than or equal to 10 m/s. In other embodiment, the rate of flow of the exhaust air may be more than 10 m/s. It is to be noted that the system 10 generates electrical energy from an original rate of flow of the non-uniform exhaust air from the air exhausting devices 12, such as, exhaust fans or ventilators. The original rate of flow of the non-uniform exhaust air refers to a rate of flow with which the air exhausting devices 12 releases the exhaust air. In other words, there is no requirement of additional components for increasing or decreasing the rate of flow of the non-uniform exhaust air for the system 10 to generate electrical energy.

The airflow distributor 102 may be configured to maintain a uniform airflow irrespective of a rate of flow of the non-uniform exhaust air and guide the exhaust air into a uniform direction, as illustrated by B in FIGS. 3 and 4, which represent uniform exhaust air. Such uniform exhaust air B in the uniform direction may be received by each of the plurality of blades, on a surface placed in the direction of the flow of the air. The uniform direction of airflow is achieved such that the uniform exhaust air contacts the surface in a direction perpendicular or substantially perpendicular. The dimensions of the airflow distributor 102 may vary corresponding to a size of the exhaust fan or ventilator. Accordingly, the dimension of the airflow distributor 102 may be customized as per requirement to generate a uniform exhaust air. In an embodiment, a width D1 of the air exhausting device is 1 m, and the length L1 of each of the plurality of blades is 70 cm. Accordingly, maximum of the exhaust air from the air exhausting device 12 is received by the plurality of blades 142, thereby resulting in higher efficiency of the system 10.

The system 10 may be used in an open space or an enclosed area. For instance, the system 10 may be used in open space, such as, rooftop of a residential building, an industrial building, and/or the like. Additionally/alternately, the system 10 may be used in an enclosed area, such as, large industrial buildings where exhaust fans are placed inside the premises. When in use, the system 10 may be configured to receive exhaust air from the exhaust fans or ventilators and further configured to generate electrical energy by converting the exhaust energy of the exhaust air into electrical energy. The generated electrical energy may be fed to a power grid for consumer distribution or may be utilized in the premises itself.

Referring back FIG. 4, a perspective view of a system 10 with an exemplary exhaust fan 12 is illustrated. The non-uniform exhaust air is passed through the airflow distributor 102 to generate a uniform exhaust air. The uniform exhaust air from the airflow distributor 102 is configured to contact the plurality of blades 142 in a perpendicular or substantially perpendicular direction as shown in FIG. 4.

In some embodiments, the wind turbine 104 may be placed in front of an industrial exhaust fan to receive the uniform exhaust air, i.e., in a path of flow of the exhaust air. It is to be noted that based on the requirement, the wind turbine 104 may be placed within an enclosed environment or over a rooftop of a residential or industrial building.

In an embodiment, the wind turbine 104 is configured to work on electromagnetic principle for generating electric energy by converting the rotation of the plurality of blades into the electrical energy using the generator. The rotor may be configured to move corresponding to the rotation of the plurality of blades, which creates rotating magnetic flux of armature coils inside a stator of the generator. In an embodiment, the armature coils are made of copper wire loops. The rotating magnetic field results in generation of AC power. The generated AC power is a non-uniform AC power. The generation of non-uniform AC power is due to varying rate of the exhaust air, and hence, varying speed of rotation of the plurality of blades 142. An exemplary embodiment includes a synchronous generator for generating electrical energy. However, any generator known in the art may be used.

The system 10 further comprises a uniform AC power generator assembly. The uniform AC power generating assembly is configured to receive the non-uniform AC power and is further configured to generate a corresponding uniform AC power. In an embodiment, the uniform AC power generator assembly includes a rectifier 106 and an inverter 108 for generating a uniform AC power from the non-uniform AC power (as seen in FIG. 4). The rectifier 106 is configured to convert the generated non-uniform AC power into a uniform DC power. The uniform DC power is converted to a uniform AC power using the inverter 108. The inverter 108 is configured to generate a uniform AC power with a frequency suitable for consumption. Optionally, the uniform AC power generating assembly may include an AC-AC controller and inverter to generate the uniform AC power.

The generated uniform AC power is configured to be utilized for different applications. In some embodiment, the generated AC power may be fed in a power grid 110. In other embodiments, the generated uniform AC power may be utilized within the premises in ongoing electrical load.

It is to be noted that even though the system has been explained using the air distributor 102, the system may be configured to work without use of the air distributor and may be configured to achieve similar efficiency and generate electric energy using the non-uniform exhaust air.

Finally, while the present invention has been described above with reference to various exemplary embodiments, many changes, combinations, and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

What is claimed is:

1. A wind turbine for generating electrical energy from exhaust energy, the wind turbine comprising:
a) a plurality of blades configured to receive a flow of exhaust air and further configured to rotate at a speed, the exhaust air being received from an air exhausting device;
b) a rotor configured to be rotated based on the rotation of the plurality of blades; and
c) a generator configured to generate an electrical signal based on the rotation of the rotor;
wherein each of the plurality of blades is of a 3D sphero dynamic shape and is attached to the rotor at a first angle so as to reduce back pressure of the exhaust air, and wherein the speed of the plurality of blades corresponds to the flow of exhaust air.

2. The turbine of claim 1, wherein the turbine is a horizontal axis wind turbine.

3. The turbine of claim 1, wherein the rotor comprises a first number of poles, the first number of poles being configured to control the speed of rotation of the plurality of blades to a first reference speed.

4. The turbine of claim 3, wherein the first reference speed is 300 RPM.

5. The turbine of claim 1, wherein each of the plurality of blades has a length of 70 cm.

6. The turbine of claim 1, wherein the turbine comprises a first number of the plurality of blades.

7. The turbine of claim 1, comprising a governing mechanism for controlling the speed of rotation of the plurality of blades.

8. The turbine of claim 7, wherein the governing mechanism comprises a controller and a furling apparatus, wherein the controller is configured to monitor the speed of rotation of the plurality of blades, and is further configured to generate a furling signal in case the speed is more than a second reference speed.

9. The turbine of claim 8, wherein the furling apparatus is configured to rotate each of the plurality of blades to a second angle.

10. A system for generating electrical energy from exhaust energy, the system comprising:
a) a wind turbine including:
i) a rotor, a plurality of blades, and a generator,
each of the plurality of blades attached to the rotor at a first angle, the plurality of blades configured to receive a flow of exhaust air from an air exhausting device and further configured to rotate at a first speed corresponding to the flow of the exhaust air, thereby rotating the rotor;
ii) the generator being configured to generate non-uniform AC power based on the rotation of the rotor; and
b) a uniform AC power generating assembly configured to generate a uniform AC power from the non-uniform AC power.

11. The system of claim 10, further comprising an airflow distributor configured to receive a non-uniform exhaust air and is further configured to generate a uniform exhaust air that is received by the plurality of blades.

12. The system of claim 10, wherein the rotor comprises a first number of poles, the first number of poles being configured to control the speed of rotation of the plurality of blades to a first reference speed.

13. The system of claim 10, wherein the wind turbine further comprises a governing mechanism configured for controlling the speed of rotation of the plurality of blades, wherein the governing mechanism comprises a controller and a furling apparatus, the controller being configured to monitor the speed of rotation of the plurality of blades, and being further configured to generate a furling signal in case the speed is more than a second reference speed.

14. The system of claim 12, wherein the first reference speed is 300 RPM.

15. The system of claim 10, wherein the furling apparatus is configured to rotate each of the plurality of blades to a second angle.

16. The system of claim 10, wherein the uniform AC power generating assembly comprises a rectifier configured to receive the non-uniform AC power and further configured to generate a uniform DC power; and an inverter configured to receive the uniform DC power and further configured to generate the uniform AC power.

17. The system of claim 10, wherein the uniform AC power generating assembly comprises AC-AC controller and inverter for generating the uniform AC power.
